(19) United States
(12) Patent Application Publication
(10) Pub. No.: US 2008/0167683 A1
(43) Pub. Date: Jul. 10, 2008

(54) Wearable teething device

(76) Inventor: Beth Ann Rodriguez, Browns Mills, NJ (US)

Correspondence Address: Andrew L. Salvatore, Esquire, Floor 13, 1818 Market Street, Philadelphia, PA, 19103, US

(21) Appl. No.: 11/649,128

(22) Filed: Jan. 4, 2007

(51) Int. Cl. A61J 17/02

(52) U.S. Cl. 606/235

(57) ABSTRACT

A device to aid in infant teething or pacifying the infant. The device may be worn around the neck or other body member of a parent or other individual caring for the infant. The device can take the form of a ring and may be worn as a necklace permitting the infant to chew or suck on the device while a parent is holding and caring for the infant. As the device is worn by the user, it is secured which reduces the risk of it becoming lost or dropped. Further, the device may be adjustable to enable the parent wearing it to adjust it to a length suitable for infant chewing. The device may be shaped with various protrusions to assist the infant in the teething process or in entertaining and pacifying the infant. The device may also contain a series of artifacts radially attached to the ring of the device.

### BACKGROUND OF THE INVENTION

1. Field of the Invention

The invention relates to a wearable teething device to be worn by a parent or other guardian to assist an infant in teething.

2. Description of Related Art

Pacifiers and teething rings are well known in the art. Typically, such devices are held by the infant while the infant chews or sucks on the device. Infants, due to their young age and lack of coordination, frequently drop such devices. If the device falls onto the floor, the device becomes dirty. The device may also fall away from the infant causing the infant to become dissatisfied and to cry. If a parent is holding the infant, the parent may have difficulty retrieving the device as the parent's attention is focused on holding and tending to the infant.

Infants also tend to place within their mouths anything within their reach. Accordingly, if a parent is holding the infant, the infant may place into its mouth a necklace or other jewelry worn by the parent. Such practice poses a danger to the infant of breaking the jewelry and ingesting small pieces of metal or stone from the necklace or other jewelry. If this situation occurs, the parent will also suffer the loss of the necklace or jewelry item.

Earlier teething or pacifying devices provided means of attaching a teething or pacifying device to the infant and teach away from parental use. In all such devices found in the prior art, the attachment means provided only the means of attachment and did not serve a separate purpose of entertaining, pacifying, or teething the infant. The inventions of the prior art did not permit the infant to chew on or play with the attachment means to entertain, pacify, or teeth the infant.

### SUMMARY OF THE INVENTION

It is an object of the present invention to provide a teething device which may be worn by a parent caring for the infant. Such device is referenced herein as a teething device but should be considered to be used also as an entertainment or pacifying device. The invention provides a device in which the attachment means also serves as a teething device for the infant. The device may contain various protrusions to assist the infant in teething. The device may also contain a series of artifacts radially attached to the ring of the device.

It is another object of the invention to provide a teething device which is worn by the parent thus preventing the device from being thrown or dropped.

It is another object of the invention to provide a teething device which is adjustable to enable the infant to have easy access to the device while the parent is holding the infant.

It is another object of the invention to provide a teething device which does not create a choking or strangulation hazard for an infant.

The present invention overcomes the limitations of the prior art, and fulfills the objects of the invention, by providing a wearable teething device to aid the infant in teething and pacifying while the parent is holding the infant. As the device is wearable, the parent is free to utilize both hands to hold the infant, and the infant can enjoy the device in close proximity to its mouth while it is being held by the parent. The infant will not be able to throw or drop the device as it is affixed to the parent. Further, the attachment means also serves the purpose of entertaining, pacifying, or teething the infant. As the attachment means is worn by the parent, it should not create a strangulation or choking hazard for the infant.

### BRIEF DESCRIPTION OF THE DRAWINGS

FIG. 1 is a general view from the top of the invention showing an exemplary embodiment of the invention.

FIG. 2 is a view of the invention showing the attachment means for various artifacts which may be attached to the ring of the invention.

FIG. 3 is view of the invention showing various means for adjustment of the size of the ring of the invention.

FIG. 4 is a view of the invention showing various embodiments regarding various constructions in which the teething device may be made.

### DETAILED DESCRIPTION OF THE INVENTION

The present invention is a device to aid in infant teething or pacifying the infant. It comprises a teething ring which may be worn by a parent to aid in teething of an infant. In practice, any individual holding the infant may wear the device, and the invention is contemplated to be useful to all such individuals. In a preferred embodiment, the device may be worn about the neck of a parent as a necklace. If worn in this manner while the parent is holding the infant, the infant, rather than grabbing and inserting the parent's jewelry into its mouth, may instead chew on the teething ring. The invention may also be worn as a bracelet on an arm of the parent.

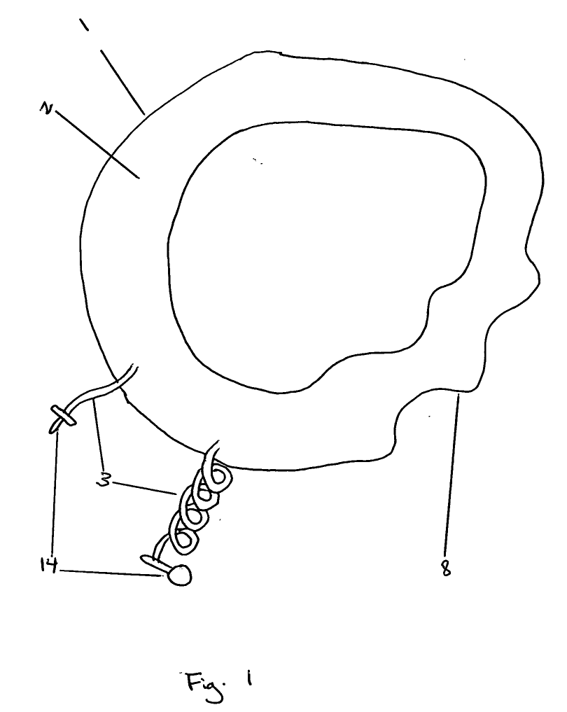

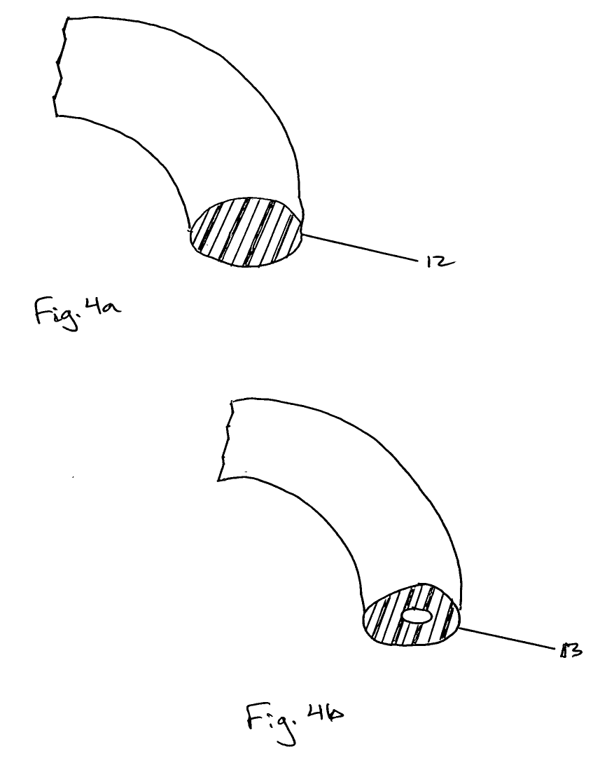

Generally, the invention comprises essentially a ring 1 with an inside diameter within the range of 5 cm to 30 cm which is adapted to fit and be worn about the neck or other body part of the parent. See FIG. 1. The ring should be of a thickness in the range of 0.5 cm to 3 cm to enable an infant to chew on the device. The ring may be constructed of a plastic or gel material such as an elastomer, polyurethane, or other material familiar to those in the art, and may be constructed of varying densities to assist the infant in teething. As the infant bites or chews, it will assist the infant in pushing its teeth through its gums. Densities of the ring may vary based on the preference of the parent or infant. A ring of this construction may be solid 12, see FIG. 4a, or alternatively, may contain a hollow cavity at its core in the form of a tube 13, see FIG. 4b.

In addition, the ring may be covered with a cloth material 2. The cloth covering provides a softer texture for the infant and may be removable based on the preferences of the parent or infant. The ring may also contain various artifacts 14 radially attached around its perimeter which can serve as an additional means by which the infant can chew or to serve as a means to pacify the infant. See FIG. 1. Such artifacts may take form of small toys, chewing rings, a child-safe mirror, a rattle or a pacifier. However, the artifacts should be of sufficient size so that if they became dislodged from the device, they should not become caught in the mouth of the infant so as to pose a choking hazard for the infant. These items serve only as examples of the types of items which may be attached to the ring and are not to be construed as a limitation of the types of artifacts which may be attached. Any item which serves the purpose of pacifying or teething may be attached to the ring. Additionally, any number of such artifacts which can reasonably fit onto the ring may be attached.

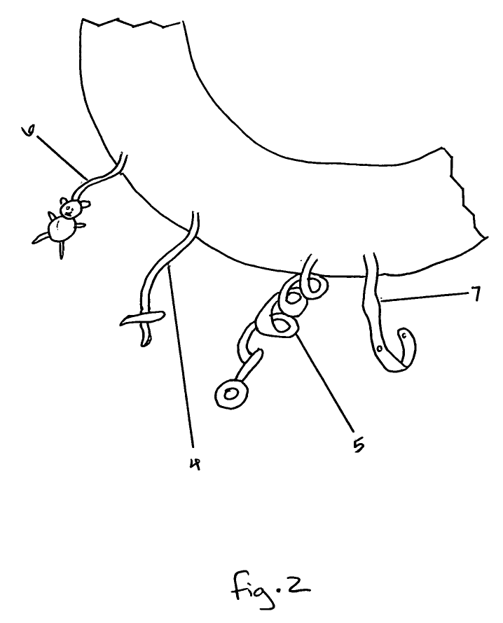

These artifacts may be attached to the ring by means of one or more tethers 3 which may be of varying lengths. See FIG. 2. The tether may be flexible 4 enabling it to stretch. In this embodiment, the tether may be constructed of elastic material. Alternatively, the tether may be constructed in the form of a spiral shaped cord that elongates as it is pulled away from the ring 5. See FIG. 2. Alternatively, the tether may be of a fixed length 6. These artifacts may be attached to the ring by means of a strip of material which snaps onto itself creating a loop 7 or by some other attachment means. The artifacts may also be permanently affixed to the ring. Alternatively, the ring itself may be shaped with bumps or ridges 8, so that in the case of teething, the infant is provided with a specific area in which to chew. See FIG. 1.

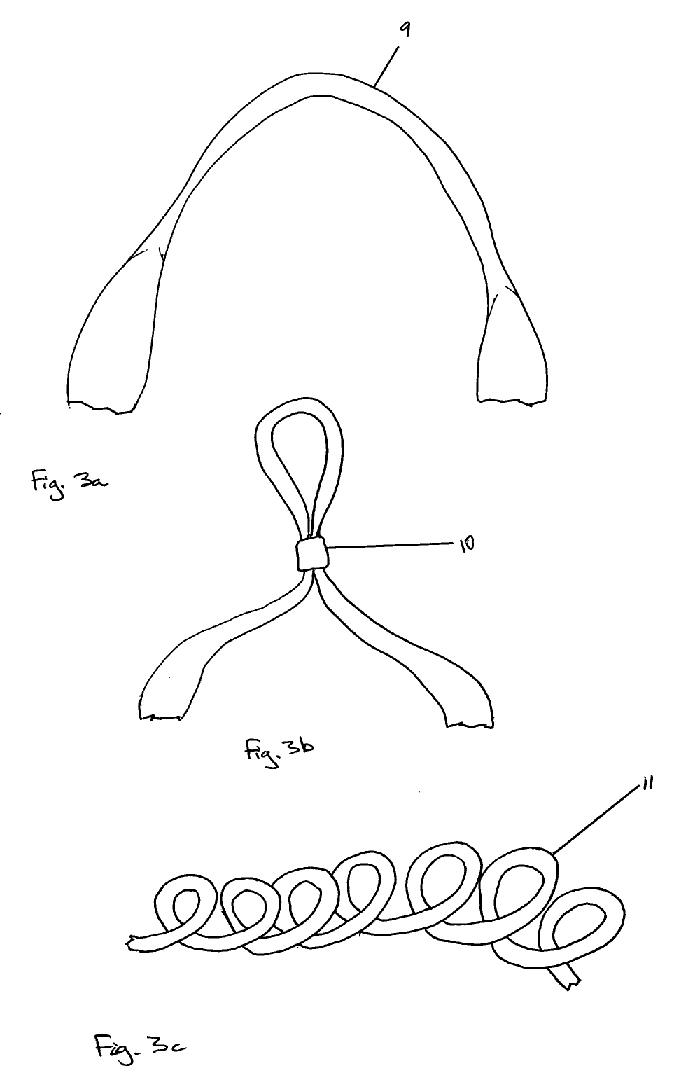

The teething device should also provide the infant with ease of access to the device. Accordingly, in one embodiment, the invention provides a means of adjusting the size of the device so that the infant can gain easy access to the device. The invention may be adjusted to larger or smaller sizes depending on the infant's distance to the parent. Alternate adjustment means include, but are not limited to, incorporating an elastic strap 9 into the device enabling the device to enlarge through elasticity. Such an embodiment is depicted in FIG. 3a. In another embodiment, the device may contain string or a cord with a slidable clasp 10 capable of adjusting the overall size of the device. This embodiment is considered to be the best mode of carrying out the invention. Such an embodiment is depicted in FIG. 3b. Additionally, the device may incorporate the shape of a spiral cord 11 which will permit the device to elongate and stretch as it the infant pulls it to its mouth. Such an embodiment is depicted in FIG. 3c.

The invention has been disclosed in terms of preferred embodiments which fulfill all of the objects of the present invention and overcome the limitations of the prior art. Various changes, modifications, and alterations from the teachings of the present invention may be contemplated by those skilled in the art without departing from the intended spirit and scope thereof. It is intended that the present invention only be limited by the terms of the appended claims.

I claim:

1. An infant teething device comprising a ring of a thickness from 0.5 cm to 3 cm to enable an infant to chew on the device to assist in teething and with an inside diameter within the range of 5 cm to 30 cm to permit the device to be worn about the neck or arm of a parent.

2. An infant teething device as set forth in claim 1 wherein the ring is covered with a cloth material.

3. An infant teething device as set forth in claim 2 wherein the cloth material is removable from the ring.

4. An infant teething device as set forth in claim 1 wherein the device contains one or more artifacts radially attached around the perimeter of the ring.

5. An infant teething device as set forth in claim 4 wherein the means of attachment of the artifacts is a fixed tether.

6. An infant teething device as set forth in claim 4 wherein the means of attachment of the artifacts is a flexible tether.

7. An infant teething device as set forth in claim 6 wherein the flexible tether is constructed of an elastic material.

8. An infant teething device as set forth in claim 6 wherein the flexible tether is constructed of a spiral cord.

9. An infant teething device as set forth in claim 1 wherein the device contains an adjustment means for adjusting the size of the diameter of the device.

10. An infant teething device as set forth in claim 9 wherein the adjustment means is an elastic strap.

11. An infant teething device as set forth in claim 9 wherein the adjustment means is a string or a cord with a slidable clasp.

12. An infant teething device as set forth in claim 9 wherein the adjustment means is a spiral-shaped cord which will permit the device to elongate and stretch.

13. An infant teething device as set forth in claim 1 wherein the device contains rounded bumps to enabling the infant to chew on the device during teething.

14. An infant teething device as set forth in claim 1 wherein the ring is comprises a plastic or gel material.

15. An infant teething device as set forth in claim 14 wherein the plastic or gel material is solid.

16. An infant teething device as set forth in claim 14 wherein the plastic or gel material contains a hollow core running throughout its center along its length.

17. An infant teething device as set forth in claim 1 wherein the ring comprises an elastic material.
